(19) United States
(12) Patent Application Publication
(10) Pub. No.: US 2006/0248209 A1
(43) Pub. Date: Nov. 2, 2006

(54) Network system for facilitating audio and video advertising to end users through audio and video podcasts

(76) Inventors: Leo Chiu, South San Francisco, CA (US); Peter Loukianoff, Oakland, CA (US)

Correspondence Address: CENTRAL COAST PATENT AGENCY, INC, 3 HANGER WAY SUITE D, WATSONVILLE, CA, 95076, US

(21) Appl. No.: 11/233,994

(22) Filed: Sep. 23, 2005

Related U.S. Application Data
(60) Provisional application No. 60/675,531, filed on Apr. 27, 2005.

(51) Int. Cl. G06F 15/16

(52) U.S. Cl. 709/231

(57) ABSTRACT

An advertising network for selecting at least one pre-designed advertisement from a plurality of such advertisements, the selected advertisement made consumable in association with a podcast multimedia offering as a commercialized podcast to a consumer base includes a receiving node ported for receiving podcast multimedia files or indication of the locations thereof and for receiving advertisement multimedia files or indication of the locations thereof; a software interface supported by a processor for obtaining data about publishers of podcast multimedia and advertisement media; a software instruction resident in memory and supported by a processor for associating the received or located advertisements to the received or located podcasts; and a publishing node ported for facilitating access of the commercialized podcasts by a consumer base. In one embodiment, files are accessed for editing and republished using real simple syndicate protocol over hypertext transfer protocol.

### CROSS-REFERENCE TO RELATED APPLICATIONS

The present application claims priority to provisional application 60/675,531 filed on Apr. 27, 2005. The entire disclosure of the above referenced provisional application is included herein in its entirety at least by reference.

### BACKGROUND OF THE INVENTION

1. Field of the Invention

The present invention is in the field of Internet media distribution and pertains more particularly to a network and system for pushing audio and video advertising to end users through audio and video podcasts downloaded to end devices.

2. Discussion of the State of the Art

The field of Internet media distribution includes availability of several media forms formatted using standard protocols for download and dissemination by a wide variety of network devices capable of receiving and playing audio and video content. For example, anyone using a network capable multimedia appliance and a network browser application may navigate to any universal resource locator (URL) hosted in a network server and download audio and video through the URL using hypertext transfer protocol (HTTP), wireless access protocol (WAP), or various other known extensions thereof created for specific device capabilities.

Audio and video compression formats, termed codecs are well known in the art and include the likes of motion picture experts group (MPEG), audio video interchange (AVI), windows media audio (WMA), windows media video (WMV), MOV, MP3, and others. There are hundreds of such codecs for decoding audio and video for presentation on an end device.

Audio and video media is generally stored on a server and associated with a universal resource indicator (URI), which when invoked by a browser application, causes the media indicated to be retrieved and sent over the network to the end user device. The link to the media selection tells the location, file type and which default player will be invoked if the link is invoked for streaming video. In this case, the media is played immediately while it is being downloaded (streaming audio/video). Streaming multimedia enables real time dissemination of content while a user is connected to the network.

More recently, a network transfer protocol based on extensible markup language (XML) real simple syndicate (RSS) has been developed to run over HTTP. RSS operates as a pushed network XML feed containing media content summaries and invoke-able links to that media content. Using RSS, Web developers may provide media content that is subscribed to, or ordered on demand by end users to a special software reader adapted to receive and display the RSS content. The full media content is not typically embedded in the RSS feed, rather a portion thereof so that, if interested, the user receiving the feed may interact with a particular selection to “jump” to the media selected.

RSS feeds have, until very recently, been used primarily for enabling users to aggregate and then browse text news stories, Web blogs, news blogs, and the like. For example, a news site might provide a RSS feed referencing a number of stories that it wishes to make available to end users without requiring them to actually browse the Web page listing the stories. One advantage of RSS is that it can save bandwidth for users navigating the Web site. Another is end-user convenience.

Another very recent development is the ability to prepare and distribute audio and video media via a phenomenon known as podcasting. Podcasting, unlike broadcasting or Webcasting does not involve a push technology. Instead, end users may subscribe to special RSS feeds, termed podcast feeds. A podcast feed may indicate audio/picture/and video offerings of one or more podcasting sources in such a way that when an offering is clicked, the files are pulled from the source site and delivered in the same way as text files are distributed. Similarly, when there are new multimedia files from the podcasting source available for download, the RSS feed automatically identifies them and may provide metadata about the offered selections including actual snippets (pictures or small audio clips of those files).

As podcasting has become more prevalent, advertisers have realized that new avenues for distributing ads are available. However, in order to sponsor a popular podcast, advertisers must locate the source and negotiate with that source. Moreover, the advertisements must be sent to the source and manually integrated with the podcast files so that the available podcast contain the advertisements when the end user downloads the files.

What is clearly needed in the art is a network and interface to enable matching of sponsors (advertisers) with (publishers) podcastors and to concatenate or multiplex the podcasts with suitable advertisements.

### SUMMARY OF THE INVENTION

An advertising network is provided for selecting at least one pre-designed advertisement from a plurality of such advertisements, the selected advertisement made consumable in association with a podcast multimedia offering as a commercialized podcast to a consumer base. The network includes a receiving node ported for receiving podcast multimedia files or indication of the locations thereof and for receiving advertisement multimedia files or indication of the locations thereof; a software interface supported by a processor for obtaining data about publishers of podcast multimedia and advertisement media; a software instruction resident in memory and supported by a processor for associating the received or located advertisements to the received or located podcasts; and a publishing node ported for facilitating access of the commercialized podcasts by a consumer base.

In a preferred embodiment, the prevailing network is the Internet network. Also in a preferred embodiment, the advertisement is one of an audio advertisement or one of a video advertisement with or without audio sound and the podcast is one of an audio podcast or one of a video podcast with or without sound.

In one embodiment, the receiving node obtains multimedia podcast files via real simple syndicate protocol feed subscription. Also in one embodiment, the receiving node obtains multimedia advertisement files via real simple syndicate protocol feed subscription. In one embodiment, the software interface is a distributed web service.

In one embodiment, data about publishers includes contact data, billing data, and preference information. In one embodiment, the software instruction depends on parsing of RSS feed content and consultation of publisher preferences and a rules base. In one embodiment, the publishing node is part of a podcast aggregation and listing service.

In one embodiment of the invention, the advertising network further includes a RSS feed subscription module running at the software interface for updating the receiving node whenever there are new podcasts to commercialize and/or advertisements for placement. In one embodiment, the location of the web service is a third party podcast aggregation service.

In another embodiment of the invention, the advertising network further includes a digital studio editor for concatenating selected advertisement multimedia files to podcast multimedia files. In one embodiment using the digital studio, the digital studio is further enhanced for mixing sound files of podcasts and advertisements together creating new multimedia files representing a commercial podcast.

According to another embodiment of the present invention, a software suite is provided for facilitating multimedia file acquisition, rendering, and publishing of those files in the form of one or more commercial podcast offerings accessible by a consumer base. The suite includes a web service interface to podcast publishers and advertisers for obtaining data pertinent service data and for obtaining targeted publisher multimedia files and advertiser multimedia files; a data processing layer for enabling matching of advertisements to podcasts; an interface to a digital editing application; and a podcast publishing layer for publishing available commercialized podcasts to the consumer base.

In one embodiment, the Web service is distributed to a third-party podcast aggregator. Also in one embodiment, real simple syndicate is used for obtaining targeted publisher multimedia files and/or advertiser multimedia files. In one embodiment, the service data includes contact data, billing data, and preference data. In another embodiment, the digital editing application is a third-party digital studio.

In a preferred embodiment, the podcast publishing layer includes an RSS feed generator. Also in one embodiment, rendering may include file concatenation of advertisement media to podcast media.

According to yet another aspect of the present invention, a method for service brokering and fulfillment for advertisement placement of an advertisement into a podcast multimedia offering on behalf of a podcast publisher and advertiser is provided. The method includes acts of (a) registering the podcast publisher for advertisement acceptance; (b) registering the advertiser for advertisement placement; (c) receiving the podcast from the podcast publisher; (d) receiving the advertisement from the advertiser; (e) matching the advertisement received to the podcast received; (f) editing the matched entities to produce a commercial podcast offering; and (g) publishing the commercial podcast offering to a consumer base.

In a preferred aspect of the method, in act (a), registration includes taking of contact information, advertisement preference information, and account information. In this aspect, in act (a), registration is accomplished though a web service interface. In one aspect of the method, in act (a), registration further includes identification of a real simple syndicate feed referencing the podcast multimedia offering targeted for commercialization.

In one aspect, in acts (b), registration includes taking of contact information, billing information, and publisher preference information. In this aspect, in act (b), registration further includes identification of a real simple syndicate feed referencing the multimedia advertisement targeted for placement.

In one aspect, in acts (c) and (d), the multimedia files are obtained via subscription to RSS feeds referencing the files as items, the items invoked to receive the files. In a preferred aspect, in act (e), matching is based in part on content relevancy and in part on monetary considerations. In one aspect, in act (f), editing is performed using a digital studio application. In a preferred aspect, in act (g), the commercial podcast is published via real simple syndicate feed.

### BRIEF DESCRIPTION OF THE DRAWING FIGURES

FIG. 1 is an architectural overview of a multimedia communications network supporting podcasting with multimedia advertising placement according to an embodiment of the present invention.

FIG. 2 is a block diagram illustrating basic software components and layers of a RSS podcast advertiser suite according to an embodiment of the present invention.

FIG. 3 is a block diagram illustrating a process of matching available advertisements to available podcasts according to one embodiment of the present invention.

FIG. 4 is a block diagram illustrating interaction between the campaign manager and host facility of FIG. 1 according to at least 2 embodiments of the present invention.

FIG. 5 is an architectural overview of a communication network supporting proxy service of RSS feeds containing commercial podcasts according to another embodiment of the present invention.

FIG. 6 is a process flow chart illustrating a basic process for commercializing a podcast on behalf of a podcast publisher according to an embodiment of the present invention.

FIG. 7 is a block diagram illustrating podcast commercialization according to audience demographics.

FIG. 8 is a process flow chart illustrating a process for commercializing a podcast and for consuming the podcast after commercialization according to an embodiment of the present invention.

FIG. 9 is a block diagram illustrating a streaming podcast advertisement process according to one embodiment of the present invention.

### DETAILED DESCRIPTION

The inventors provide a network-based system and methods for providing third-party advertising within downloadable multimedia podcasts. The methods and apparatus of the present invention are described in enabling detail below.

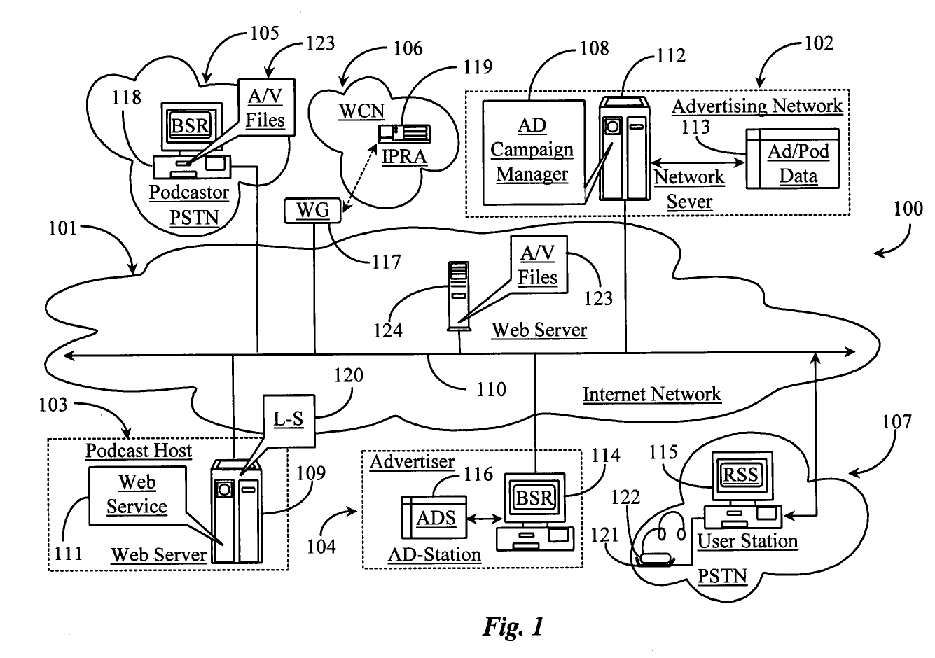

FIG. 1 is an architectural overview of a multimedia communications network 100 supporting podcasting with multimedia advertising placement according to an embodiment of the present invention. Communications network 100 includes a plurality of sub-networks, which have connection to a wide-area-network (WAN) 101, which in this exemplary overview, is the Internet network. WAN network 101 shall be referred to in this specification as Internet 101 for discussion purposes as one preferred embodiment. Network 101 may be a private corporate WAN, a wirelessly accessed municipal area network (MAN), or some other data packet network (DPN) without departing from the spirit and scope of the present invention. The inventor chooses the Internet in a preferred example because of the common and well-known protocol standards transmission control protocol over Internet protocol (TCP/IP) and RSS over HTTP that are leveraged to practice the present invention.

A podcast host portal or facility 103 is illustrated in this embodiment and represents an Internet based Web service or portal that provides access to podcasts created and published by third parties and aggregated for public access. Podcast host 103 may be a popular news portal, an Internet Service Provider (ISP) portal, or any other network access or network based service without departing from the spirit and scope of the present invention. Podcast host entity 103 includes a Web server 109 illustrated therein. Web server 109 is adapted to provide services to users accessing the host from points on the network. Server 109 has network connection to an Internet backbone 110 illustrated within the domain of Internet 101. Backbone 110 represents all of the connection points, access lines, carrier lines, and equipment that make up the Internet network as a whole. Therefore, there are no geographic limitations to the practice of the present invention.

Web server 109 has a Web service 111 installed therein and accessible there from. Web service 111 may be a service that aggregates or accepts podcast multimedia from podcastors and aggregates those for access by network-connected users interacting with server 109. An example of service 111 may be that of a RSS feed aggregator that includes podcast multimedia among the available items described by those feeds. Popular portals and more recently formed Web-based information services offer such Web-based services to the general public. Such services generally provide users with access to news media and RSS-carried content including text news articles, Web logs (Blogs), and more recently some have made podcasts available. In this case, server 120 has a link service application L-S 120, which may be adapted to provide specific server-to-server links to other Web-based servers such as Web proxy servers. More detail about the use of a proxy server to access services hosted within server 103 is provided further below.

A Public Switched Telephone Network (PSTN) segment 105 and a PSTN segment 107 are included within communications network 100. PSTN 105, in this embodiment, includes a podcastor station 118. Podcastor station 118 may in one embodiment, be a personal desktop computer station having connection to Internet backbone through an ISP (not illustrated) using PSTN telephony equipment and lines to access the Internet. Internet access capability is illustrated herein as a browser (BSR) application running on the video display unit (VDU) of station 118. Station 118 may also be any other computerized station having Internet access and navigation capability including the capabilities to create podcasts and RSS files that may be published that point or link to podcast audio and, in some cases, video files. It may be assumed in this example that station 118 is equipped with all of the necessary multimedia software and hardware for creating audio and audio/video podcasts and for creating the RSS files that are published and that point to the appropriate presentation files of those podcasts.

In one embodiment of the resent invention, podcastor 118 may be creating and publishing podcasts and text articles that are pertinent to a Website owned by the podcastor, or otherwise managed by the podcastor. Such a Website may be maintained in a Web server illustrated in this embodiment as a Web server 124 within Internet 101. Therefore, any multimedia files represented by RSS-embedded content items may be locally stored or remotely stored. For example, audio and video files (A/V Files) 123 are illustrated in this example as stored locally on station 118 and as stored remotely on server 124 in conjunction with a Web site. The only requirement for practicing podcasting is that the actual files comprising the podcast and which are referenced in RSS are available to the end user browsing the network with a reader capable of browsing RSS feeds.

PSTN segment 107 includes a multimedia user station 115 having connection to Internet backbone 110 via an Internet access line. Station 115 may be a personal desktop computer, a laptop computer, or a host of other network-capable devices with VDU and audio presentation capabilities. In this case, station 115 includes a peripheral audio hardware device 122, termed hereinafter a player. Player 122 rests in a cradle 121 that is cabled to station 115 by a Universal Serial Bus (USB) or the like. Player 122 is removable from cradle 121 and includes a headset audio speaker system for presenting audio and, in some embodiments, a VDU for displaying associated video data. Station 115 is illustrated with a RSS reader application displayed on the VDU. The RSS reader may be one of a host of available readers, many of which are free to download and use.

One with skill in the art of general RSS navigation will understand that the RSS feeds subscribed to or otherwise accessed from station 115 through reader 115 may be those from a wide variety of sources and that the use of RSS in this embodiment simply provides the mechanism through which podcasts are published and accessed as are other types of RSS carried data. More importantly, the RSS feeds provide the links through which entire multimedia presentations are accessed whether they are text articles, text with graphics, audio (podcast) or audio/video (videocast). Typical podcast content may include news, shows, songs, blogs, etc. More recently, video has been added to the available content.

A wireless carrier network (WCN) 106 is illustrated as one of the sub-networks of communications network 100. WCN 106 may be any digital wireless telephony network capable of providing wireless Internet access to end users operating network-capable devices. An Internet protocol radio appliance (IPRA) 119 is illustrated within WCN 106 and typifies one type of network-capable appliance that may be leveraged to receive multimedia content from Internet 101. IPRA 119 communicates with a wireless gateway (WG) 117, which in turn has connection to backbone 110 via an Internet access line. WG 117 is a wireless access router or gateway that may be provided by any one of a host of known wireless Internet services.

In this embodiment, IPRA 119 may be a mobile device placed in a convenient location at the location of an end user or it may be a device installed in an automobile as an in-dash type system capable of accessing the Internet through WCN and through gateway 117. Other wireless network-capable multimedia devices may also be included as a wireless appliance in WCN 106 without departing from the spirit and scope of the present invention. For example, a wireless cellular telephone having multimedia and Internet access capabilities may be used. A Laptop computer having multimedia capabilities and Internet access capability may also be used to practice the present invention.

In the case of cellular telephones and Laptop computers, RSS reader capability may be conveniently provided including VDU interface for browsing and accessing RSS feeds and the podcasts referenced therein. In the case of IPRA 119, a VDU may be provided in the form of a liquid crystal display (LCD) or other form for full RSS reading and interaction capability. In another case, IPRA 119 may not use RSS to enable access to podcasts. In this case, a series of podcasts may be associated with a particular radio station that the operator of IPRA 119 may subscribe to whereby the links to the podcasts are automatically invoked and the multimedia automatically streams to the device over the channel. In still another embodiment, the studio proving IP radio programming integrates the podcast materials into IPR programming personalized to the user after the end user has indicated, through another network-capable device, which podcasts he or she will subscribe to. There are many possibilities and RSS is not specifically required in order to practice the present invention in all cases.

An advertising network host 102 is illustrated in this example and provides a brokering service and advertisement studio service for advertisers wishing to place advertising into podcasts for download to end users. Advertising network host 102 may represent any business that provides a common interface to both advertisers and podcastors for the purpose of negotiating ad placement within selected podcasts. An advertiser facility 104 is illustrated in this embodiment and represents any advertisers having audio and video ads for placement through podcast media to end users.

Advertiser facility 104 includes an advertising station 114 and a connected advertisement database 116. Station 114 may be a personal desktop computer with a VDU having access to network backbone 110. It is assumed in this example that station 114 is equipped with all of the necessary software and hardware for creating audio and, in some embodiments, audio/video advertisements for placement into podcast media. Database 116 may represent advertisements already created and stored for use in one embodiment. In one embodiment, station 114 may be an ad streaming server without departing from the spirit and scope of the present invention. Such an embodiment will be further detailed later in this specification.

Advertising network host facility 102 includes a network server 112 running an ad campaign management application 108. Network server 112 has connection to backbone 110 in Internet 101 via a high-speed Internet connection line such as DSL or cable. A database 113 is illustrated within host facility 102 and has a data connection to network server 112. In this embodiment, database 113 may be adapted to contain both advertisements and podcasting files, as well as other data that may be relevant to advertisers and to podcastors that have registered with advertisement brokering services offered through host 102.

Ad campaign manager 108 provides a service or services for registering podcastors who wish to host advertising in their podcast programs and a service or services for registering advertisers who wish to advertise in podcast media. Furthermore, ad campaign manager 108 may provide a service or services for matching advertisement content with podcasting content to determine content relevancy of placed advertisements. Additional services available within network host facility 102 may include the ability to edit podcast media to embed relevant advertisement media therein for re-package and delivery. In one embodiment, ad campaign manager 108 also provides an end user portal or interface for users to search out and subscribe to podcasts containing advertisements. There are several possible embodiments for mixing advertising into podcast media and making the content available to end-users over the network. Some of these embodiments involve working in cooperation with an existing podcast host facility and others involve hosting podcast feeds separately from other third party facilities.

In general practice according to current art, a podcastor such as one operating at station 118 creates one or more podcasts and publishes a RSS file referencing those files. In current art, podcastor 118 using RSS software may publish the existence of the podcast(s) to podcast facility 103 to be aggregated for public accessibility by Web service 111. End users like one operating at station 115, for example, may access Web server 109 using a suitable RSS reader and access available feeds containing summary items representing those podcasts. Each summary item may contain a text description identifying the podcast and perhaps a graphic or short audio sample of the podcast. Each summary item also contains a Web link to the entire podcast, which may be accessed and streamed from the source to the end user device. A local player like player 122 or a software player may be used to playback the files after downloading them, or as they are streamed to the device. For audio podcasting, there is no current network or method for providing third-party advertisements into those podcasts. Moreover, some of those podcasts may require payment of some kind such as for podcast music files where the entire song is also available for download.

According to one embodiment of the present invention, podcastor 118 for example, may register with a service offered by advertising network host facility 102 in order to receive some compensation for a willingness to provide advertising space within a podcast created for mass download by end users. Likewise, an advertiser like advertiser 104, for example, may register with the same service hosted by advertising network facility 102 in order to have created advertisements delivered within available podcasts.

Ad campaign manager 108 may provide these registration services for publishers (podcastors) and advertisers. The source of interaction in providing the registration services may be within Web server 112. In one embodiment a Web service link may be provided on a Web page hosted within server 109 redirecting podcastors to a URL in Web server 112 where registration services may be accessed. In registration, the podcastor identifies RSS feeds by URL and indicates which content within a feed may be targeted for ad insertion.

An advertiser may register to have advertisements matched with podcasts based on content relevancy and on advertising costs to place an advertisement. Advertising costs may vary according to characteristics of the podcasting source and the popularity of the content of the podcastor or of the podcastor or hosting agency itself. An advertiser may indicate one or more subject types or content types that would be relevant for specific advertising. For example, a podcast fishing show may attract advertisers who sell fishing boats and motors, as well as those who sell lures other and fishing gear.

Once a podcastor is registered with the service and has provided information that the service may use to access the podcastor feed, campaign manager 108 may access the feed, and parse it to isolate the specific content (item) to be edited for advertisement. The service may then retrieve the content for editing. Ad campaign manager 108 may also be used to match available advertisements to the podcast content based in part on content relevancy and in part on demographics known about the expected audience of the podcast. In one embodiment, an advertiser may make advertisements available through RSS feeds (adcasts) whereby those advertisement items in a feed represent the different audio or audio/video advertisements available. Campaign manager 108 may therefore access an advertiser's feed to retrieve relevant advertisements for placement.

In another embodiment, the podcastor and advertiser may simply upload the podcasts and advertisements that they wish to target for service at the time of registration and periodically thereafter when they create new content that they wish treated. RSS is just one convenient way for the service to obtain the material for editing. The campaign manager may subscribe to the feeds and therefore may be notified whenever a new a new podcast is available for editing. In the case of an advertisers feed, the service may determine whenever a new ad has been created for service.

Podcast files and advertisement files may be obtained and stored in database 113 along with other pertinent registration information about podcastor clients and advertiser clients. The brokering service of the invention is primarily focused on selling advertising space to advertisers and on providing advertisement placement services to podcastors.

Advertising network host facility 102 also provides all of the capability of a multimedia editing studio for the purpose of enabling overlays, cutting and pasting, audio channel mixing, and other editing capabilities that are currently used in state-of-art audio and video commercial editing. Therefore, it may be assumed that facility 102 may also contain editing workstations, multiplexing equipment, and other related hardware.

When editing a podcast with advertisement data, campaign manager 108 may use a variety of know methods including providing timed audio advertisement spots in concatenation with the retrieved podcast files such that the advertisement plays immediately before or after the podcast. In one embodiment, the podcast is cut in appropriate sections and advertising is inserted into advertisement space created in the podcast. In still another embodiment, audio advertising can be streamed in conjunction with a portion of the podcast and re-produced or mixed to provide a new podcast containing the advertising in appropriate sections.

All other audio editing tools such as volume control, fade, equalization, and the like are available within the studio portion of the software of the invention. Moreover, the software of the present invention may rely on current and existing digital multimedia editing tools provided by any suitable off-the-shelf video and audio editing solutions or products without departing from the spirit and scope of the present invention.

In a preferred embodiment, campaign manager 108 includes a studio interface as described further above for editing podcasts with advertisements so that the final podcast version after edit contains the advertisement or advertisements in audio and in some embodiments, audio/video format. The service of the invention relieves podcastor of any editing tasks associated with creating or modifying files to contain or carry advertising or to be linked to any specific advertising before publishing material. Likewise, advertisers do not have to coordinate with content source entities (podcastors) in order to negotiate an advertising position with the podcastor.

After one or more podcasts obtained (copied) from an available RSS feed have been edited to contain, carry, or to be linked to one or more advertisements, they may be published as new and separate items by the service back to the original RSS feed that references the original commercial free items. In this way, end users subscribing to those feeds have an option to select a commercial free podcast or to select a commercial version of the same podcast. An incentive for end users may be that the commercial version of the podcast in question may be free for complete dissemination whereas the commercial free version may only be available for a price. An example of such a condition may be where a commercial free podcast of a new release by a popular artist costs $1.50 to download and play on an Ipod, for example, whereas the commercial version may be downloaded and played free of charge. The artist may have incentive to release both versions to the public because he or she may be compensated for either version.

In one embodiment, after podcast items from a RSS feed are retrieved and edited, the commercial versions of those podcasts may be published to a separate commercial RSS feed hosted by advertising network facility 102, perhaps available through server 112. In this way, a new subscriber base may be created from end users willing to listen to advertising while listening to podcast content. Hyperlinks may be provided in association with the original podcast hosting service 103 so that users may “jump” to the commercial feed if desired. Some compensation may be provided to host 103 in return for the linking capability. It is noted herein that the RSS summary metadata associated with an item may point to a reference URL from which the podcast may be immediately executed or not. There may be additional options presented once a user executing a feed item arrives at the URL destination. Such options are not necessarily reflected in RSS data, but may be presented to users once connected to a URL hosting the item or items. In addition, pop-up notifications may also be used, for example, to inform a user that a commercial version of this podcast program is available at no charge by clicking here.

In the case of a wireless IPRA such as IPRA 119, for example, commercialized podcasts may be made available for subscription by aggregating those into a radio channel that may be displayed on a scrollable LCD display window on the device. The programming of such a “commercial” channel may be identical to that of a “commercial free” programming of another radio channel or station save for the added advertising carried in each commercialized item programmed to play on that station. In this case, the commercial channel may be free whereas the commercial free channel may be associated with a subscription fee.

One with skill in the art of podcasting and publishing of RSS files referencing podcasts will understand that RSS feeds may be created that are individual to one podcastor, or that aggregate items created by a variety of podcastors into one feed. The only requirement for publishing a commercial podcast is that the metadata summary of the item at least links the end user to the podcast file, as it is also possible to provide secondary linking to the advertisement files to be concatenated or played with the podcast. For example, by adding a tag line to a podcast summary, the player that will play the podcast may, with a small plug-in be enabled to “look” for an ad stream that has been pre-associated to the content of the podcast. This may be accomplished similarly to a player “looking” for codec from the Internet before playing a media selection. Instead of codec, the player navigates to the advertisement source and downloads the ad files, which may be synchronized to play in conjunction with or in concatenation with the podcast. Such an embodiment just described will be described in more detail later in this specification.

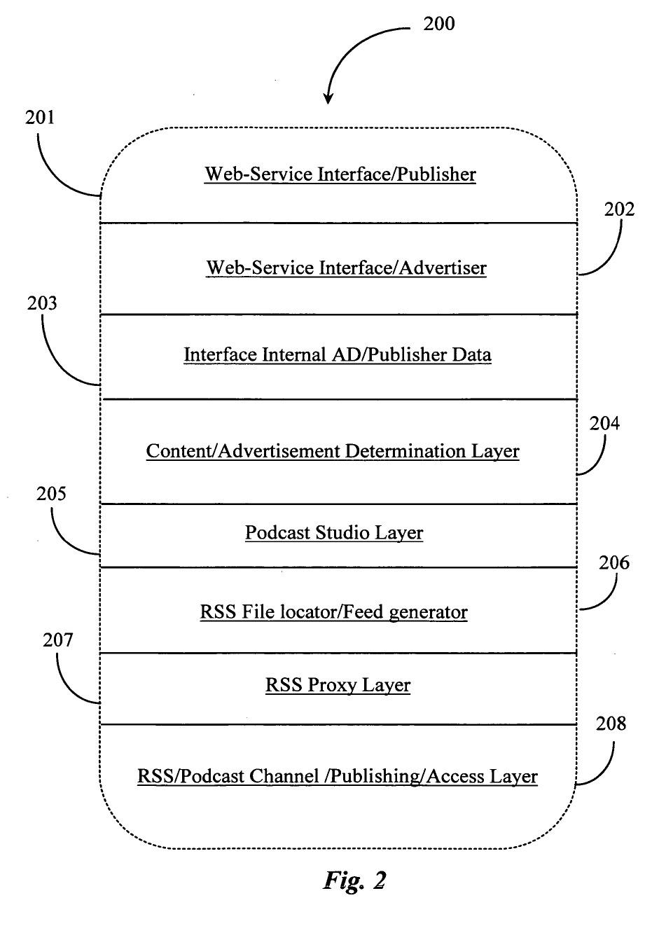

FIG. 2 is a block diagram illustrating basic software components and layers of a RSS podcast advertiser suite 200 according to an embodiment of the present invention. In this embodiment, additional components are described, some of which may be optional components according to some embodiments of the present invention.

Podcast advertiser suite (PAS) 200 may include the components of the campaign manager 108 described with reference to FIG. 1 above. PAS 200 has a Web service Interface 201 to publishers (podcastors) of podcast content to enable them to register with the service and to begin carrying advertising within their podcasts. Interface 201 may be provided in the form of a Web interface beginning with service registration including electronic forms for population and submission of required registration data. Interface 201 may require also that the applicant fill out other forms to submit other types of data that may be used to help determine the nature of advertisements that are suitable for presentation through the published content. Information submitted may include but is not limited to contact information, account information, advertiser preference information, compensation information, content (podcast) description, RSS feed/file location, and so on. Campaign manager 108 uses some of the information provided to help match the podcasts with suitable advertising.

PAS 200 includes a Web service interface 202 to advertisers. Interface 202 is similar to interface 201 but is dedicated to advertisers having advertisements to place. Interface 202, like interface 201 may be provided in the form of a Web interface to advertisers beginning with service registration including electronic forms for population and submission of required registration data. Interface 202 may require also that the applicant fill out other forms to submit other types of data that may be used to help determine the nature of available podcasts that are suitable for placement of the advertisements. Information submitted may include but is not limited to contact information, account information, publisher preference information, advertising budget information, content (advertisement) description, RSS feed/file location, and so on.

It is important to note herein that Web-service interface layers 201 and 202 may interface with Web services distributed to a podcast aggregator host like host 103 of FIG. 1. In this case, a link for both podcast publishers and advertisers may be provided to enable service registration and data submission. In one embodiment the advertiser interface may linked to from any major advertising portal or from any other website. Such web links to enable navigation to and interaction with campaign manager 108 may be distributed through electronic mail, embedded in URLs, and so on. There are many possibilities.

PAS 200 has a data interface 203 to system internal, or to a locally managed advertiser/publisher database similar to database 113 described with reference to FIG. 1. Interface 203 enables the application to manage, input, and retrieve data for use in other tasks performed by the software. In one embodiment, the data managed may include account data for publishers and advertisers, advertisement matching statistics and history, advertisement placement statistics and history, frequency of use statistics, publisher compensation schedules and history, advertiser payment schedule and history and general billing histories and data. In one embodiment, data managed may also include performance statistics related to traffic accessing commercialized podcasts. Performance statistics related to advertisement placement may also be provided.

PAS 200 includes, in this embodiment, a content/advertisement determination or matching layer 204. Layer 204 is responsible for making system determinations about which advertisements should be placed with which podcasts. Determining which advertisements to place with which podcasts may be determined by several criteria. One criteria is preferences submitted by podcastors and advertisers. Another criteria may be actual content relevancy. For example, an advertisement for fishing gear may be placed with a podcast about new fishing places, for example. Yet another criteria may be associated with cost, for example, what an advertiser is willing to pay or what amount of compensation a podcastor demands. Podcasts are currently rated according to subscriber ship and can be also be rated by actual downloads for a given period. Therefore, the system of the present invention can readily create an appropriate rate scale that may be applied for certain advertisers and certain podcastors.

“Bill and Jim's fishing” podcast may, for example, be rated in the top 200 podcasts at a podcast listing service. By the same token, “Rowland Martin's bass fishing techniques” may be the number one rated podcast covering the sport of fishing. Therefore, an advertisement placed in the latter podcast would be much more expensive for the advertiser than the same advertisement placed in the first podcast. Also considered would be criteria set by podcastors and advertisers. For example, Rowland Martin may place a minimum amount on advertisements placed in his podcasts. An advertiser like Siren, which makes fishing line, may place a ceiling on what they are willing to pay to place an advertisement regardless of where it may be placed. Campaign manager 108 may provide some pricing guidelines along with rating information for available podcasts. Likewise, there may be some time limitations applied for ad placement as well as different pricing for placement during different seasons or months of a year, or even time of the day.

All of the criteria required and all of the negotiation for ad placement may be brokered through the Web service interfaces. PAS 200 also has an ability to remove advertising from a podcast and replace it with different advertising following a revolving advertisement scheme. There are many possibilities. It is noted that as with commercial advertising for television, there may be a drop dead time limit imposed for advertisers who compete for placement in order to provide fairness to the process.

PAS 200 may include a podcast studio layer 205 for enabling podcast editing to insert advertising. Studio layer 205 may include all of the necessary tools for working with digital sound and video files including mixing input and outputs to monitoring and mixing equipment, cut and splice tools and window in window tools. Advertisement files may also be concatenated to podcast files to play before or after the podcast. There are many possibilities, one of which includes synchronized file streaming and multiplexing separate streams at the location of an end user downloading the file.

In one embodiment of the present invention, layer 205 is just an application program interface (API) to an existing state-of-art sound and video-editing studio. In this case, podcasts files and advertisements may be input into the studio application for editing and then output back to PAS 200 when finished. PAS 200 may then store those files and update the RSS feeds where necessary to publish the new podcast.

In one embodiment, PAS 200 includes a RSS feed and file locator and a RSS feed generation layer 206. The software includes the ability to subscribe to and parse any RSS feed for content and to retrieve and parse the retrieved content. In one embodiment, campaign manager 108 uses some version of a RSS reader to locate available podcast feeds. In one embodiment, a podcastor (publisher) registers with the service of the present invention and indicates the location of the RSS feed containing his or her podcast items so that layer 206 may access the feed and items referenced in the feed. In this embodiment, a RSS feed from a host like podcast host facility 103 of FIG. 1 is monitored for update through subscribing to the feed. When the feed is updated with a new podcast, PAS 200 aided by layer 206 accesses the feed continuously or periodically and retrieves any new item contents (actual podcast). If a podcast can be associated with a registered publisher who has agreed to advertising placement, then the software may, aided by layer 204, begin the process of commercializing the podcast contents and re-publishing the new podcast with the aid of layer 208.

Layer 206 may also generate its own RSS feed and populated it with commercial podcast offerings. A RSS feed like this may provide many categories of subject matter, which may be searchable. In this embodiment, the advertisement broker would publish one or more RSS feeds whereby interested users may obtain low cost or no cost content if they are willing to listen to and, in some embodiments, view the accompanying commercial content from the advertisers.

PAS 200 may also, in one optional embodiment, include a RSS proxy layer 207. Proxy layer 207 may be used as a proxy interface between end users and the host podcast listing facility they currently go to look for available podcasts. In this embodiment, end users may elect to use a proxy server (hosted by the advertisement broker) for the purpose of being able to “see” and “search” all available commercialized versions of popular podcasts in addition to the commercial free offerings. The end user then may make a choice as to which version, commercial or not, of a particular podcast offering he or she is interested in. RSS proxy layer 207 may also be used between podcastor publishers and advertisers when setting them up for use of the service. In the case of a proxy for example, a podcastor may publish a RSS file referencing content on his or her local hard drive to a RSS feed aggregator. At the proxy, the files may be retrieved and recorded for latter commercial editing while the RSS file being published is passed on to the original server. In another embodiment, of course, the podcast publisher uploads a newly created podcast directly to the service site of the present invention for editing.

PAS 200, in one embodiment, optionally includes a RSS podcast channel publishing and access layer. Layer 208 may be used as an interface layer for uploading podcast files and for publishing RSS files pointing to podcasts. Layer 208 may additionally be used as a Web directory for end users searching for podcasts. In one embodiment, layer 208 works in conjunction with proxy layer 207 for RSS-based podcasts so that end users may alternately select commercial or non-commercial versions of a same podcast. In this case, the commercial versions are presented in a host RSS feed provided by the advertisement broker. Non-commercial podcasts may be accessed from the directory feed where they are published in commercial free format. Therefore, a RSS feed first accessed may reference both podcast versions side by side. If a user selects a commercial free version then the aggregation site is tapped to locate the podcast or link to it. If a commercial version (item) is selected, then the broker site hosts the feed and actual contents.

In one embodiment, campaign manager 108 described with reference to FIG. 1 above provides registration services for advertisers and podcast publishers using a publisher processor and an advertiser processor and also site or feed monitoring software (to detect updated feeds) and a content composer that may be leveraged to parse the RSS feed for updates and retrieve the podcast contents for editing. In this embodiment, the campaign manager may also responsible for podcast editing with the aid of studio software. The added layers 207 (proxy layer) and 208 (RSS/Podcast channel/publishing/access layer) may comprise PAS 200 including all of the functionality of campaign manager 108. In other embodiments, described layers and components may be distributed over several machines or networked nodes without departing from the spirit and scope of the present invention.

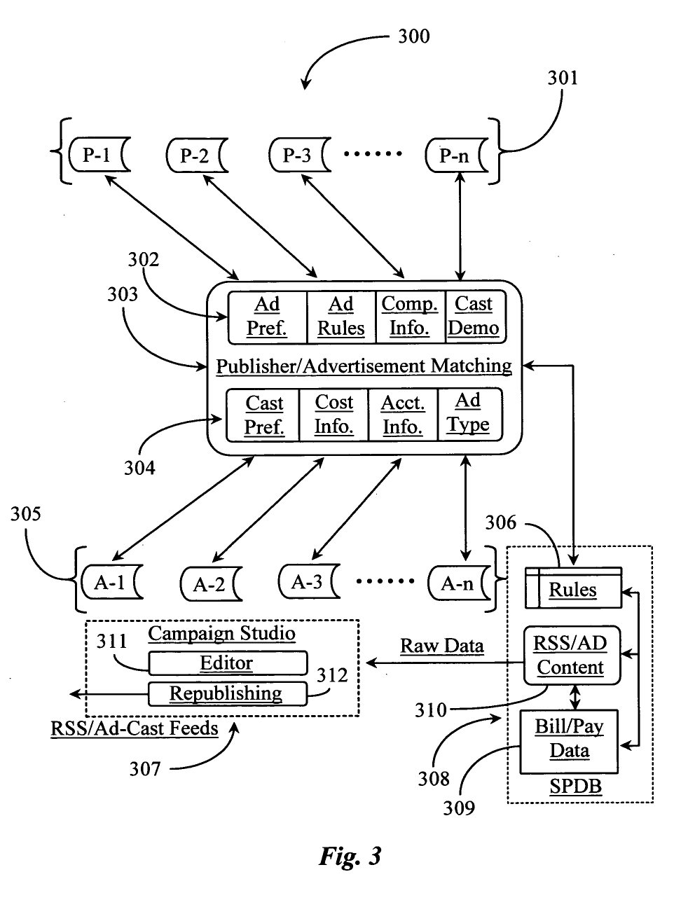

FIG. 3 is a block diagram 300 illustrating a process of matching available advertisements to available podcasts according to one embodiment of the present invention. Available podcasts for commercializing are illustrated in this example as podcasts 301, P-1 through p-n. Podcasts 301 are those that have been retrieved from RSS feeds, or otherwise uploaded to the service of the present invention for editing or commercializing. Available advertisements are illustrated in this example as advertisements 305, A-1 through A-n. Advertisements 305 are those that have been retrieved from RSS feeds, or otherwise uploaded to the service for ad placement.

A publisher/advertisement matching block 303 is logically illustrated in this example, and represents the portion of the service that matches available advertisements to podcasts being commercialized. Block 303 may logically represent function provided by a publisher processor and an advertiser processor described further above with respect to an embodiment of campaign manager 108 of FIG. 1. Matching advertisements to available podcasts may involve several criterions. For example, a block 302 logically represents just a few of the attributes or preferences that may be collected from individual podcastors (publishers) before matching podcasts to available advertisements take place. Some information that may be used in part to determine appropriate advertising for any specific podcast may be solicited during podcastor registration. In this example, advertisement preferences (Ad Pref.) indicated by the podcastor may be one of the criteria used in ad-matching. Advertisement preference may be a general preference for a content or category of advertisements. In one embodiment, an advertisement preference may include indication of a preferred advertising entity or company.

A podcastor may, in one embodiment, be allowed to create certain advertising rules (Ad Rules) governing, for example, how advertisements may be associated with a podcast. One rule may constrain advertisements to a specific maximum duration. Another rule may constrain placement of an advertisement to specific areas or advertising space within a podcast. Still another podcastor rule may physically constrain how a podcast is commercialized. For example, a rule may request that advertisements be placed only at the beginning or at the end of a podcast. There are many possibilities.

Another criteria that might be considered in placement of advertising into a podcast is the compensation information (Comp Info.) relating to what revenue structure the advertiser is willing to observe for the opportunity to advertise through the podcasts of a specific publisher of those podcasts. A podcastor may not wish to carry any advertising unless a minimum compensation structure is established for ad placement. Advertisers not willing to meet a minimum compensation may not receive the opportunity to place advertising with a particular publisher. Another possible criteria that may be used to match advertising to podcasts may be podcast end-user demographics (Cast Demo.). For example, if a preponderance of those accessing a particular podcast are west-coast listeners, advertisements for products locally or regionally available to them might be considered before other advertisements. Other demographic factors, if known, about a typical podcast audience or subscriber base can be used to help match available advertising to a podcast. For example, gender of audience, average age of subscribers, physical location of subscribers, average annual income of subscribers, and many other factors might be used singularly or in combination to help match advertising to podcasts.

Like publishers of podcasts for commercialization, advertisers may also be solicited for data that may be used in part to match their advertisements to available podcasts. For example, a block 304 logically represents just a few or the data types that may be solicited during registration. An advertiser may be asked if there is a preference for advertising through a certain podcast type, category, or even a preferred podcastor (Cast Pref.). In podcasting, podcasts and podcastors may be rated according to success, subscriber-ship, and other factors. Highest rated podcastors or podcasts may generate higher advertising revenue.

Another criteria that may be used in part to match advertisements with podcasts may be cost information (Cost Info.). Cost guidelines might be presented to an advertiser and an advertiser may indicate a budget level or maximum cost he or she is willing to pay per ad according to specific podcastor. In one embodiment, an advertiser may preview podcasts to determine which podcasts he or she wishes to provide advertising for.

Account information (Acct. Info.) is typically collected so that the advertiser may be billed for placement of specific advertisements. In one embodiment, advertisers may set up an ad account or budget in advance of having advertisements matched and placed into podcasts. Other information collected that may be used in part to match advertisements to podcasts may include ad description or ad type. Ad type or description is simply a summary description of the product or service advertised and any other relevant data that would be used to identify the ad subject matter. For example, an advertisement for fishing gear would not necessarily be matched to a podcast covering the NASCAR racing circuit. However, a podcast about local reservoirs and campgrounds may be a good match for an advertisement covering some fishing product or products.

In a preferred embodiment, a combination of criteria may be used to match advertisements to podcasts, including criteria observed by the service provider. For example, a service provider database (SPDB) 308 may be provided and adapted to contain all of the required data in order to practice the present invention including a rules base 306 adapted to contain and serve rules relevant to the service operation and to publishers and advertisers. Operational rules may pertain to rules like rotate advertisements for this podcast every 6 hours. This might be a rule used in a rotation advertisement scheme. Publisher rules and advertiser rules set at registration may also be stored and accessed from rules base 306. In this case, each publisher and advertiser in the system may have their own customized rules that fit within the domain of the broader system rules that may apply.

SPDB 308 may have a memory cache 310 or other type of memory adapted to temporarily contain and serve actual RSS content, which may include podcasts, advertisements, and other data. It is not specifically required for the service to store actual commercialized podcasts locally for consumer access through a published RSS feed in order to practice the present invention. In one embodiment, the service provider has its own RSS feed that it publishes and the “commercial casts” may be referenced in that feed regardless of where the actual item files (podcast files; ad files) reside.

Once RSS content is parsed and all required items are obtained for commercial editing purposes, the raw data, comprising essentially of a podcast for editing and the advertisement files matched to that podcast, is sent to an editing portion of the suite, in this case, a campaign studio block 307. In this example Block 307 logically represents podcast editing functions and capabilities and contains an editor block 311, and a republishing block 312. In this embodiment, editor block 311 is used to modify a podcast to contain the advertisements previously matched to it.

Republishing block 312 may be used to republish a podcast with advertising or in other words an “ad-cast” to the original RSS feed it was retrieved from or to a new RSS feed. If republished to the original feed, the new item may link to the new content wherever it is stored for access. It may be stored on the same server the original podcast is available from, or it may be stored on a different server.

SPDB 308 includes, in this example, a bill payment data block 309 that may be adapted to contain updated account information for advertisers and for publishers. Such updated information may include amounts owed to publishers for carrying advertising in their podcast items, and amounts owed to the service from advertisers whom have had their advertisements matched and placed by the service. In one embodiment, publishers and advertisers may subscribe to their account information via secure or encrypted RSS so that anytime ads are placed or compensation is due, the publishers and advertisers may be notified via their own RSS reader programs. In another embodiment, other known or common billing methods and mechanisms may be used.

It will be apparent to one with skill in the art that the method of the present invention may be used to alleviate much work associated with pre-negotiating between podcast publishers and advertisers for placing advertisements into podcasts. Likewise, all of the studio editing tasks associated with commercializing multimedia content with advertisements can be eliminated on behalf of publishers and on behalf of advertisers.

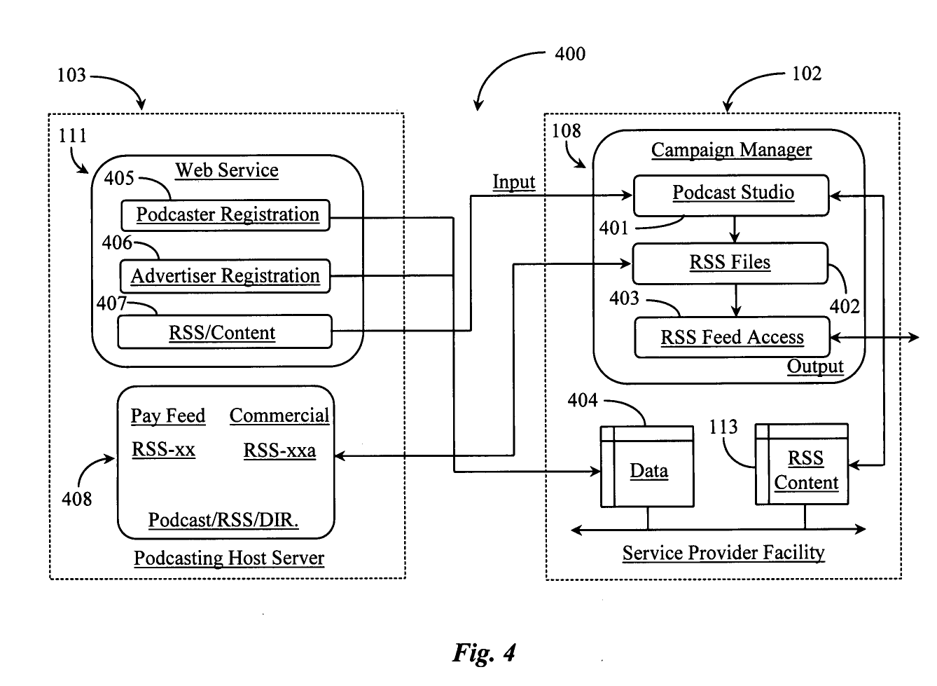

FIG. 4 is a block diagram 400 illustrating interaction between campaign manager 102 and host facility 103 of FIG. 1 according to at least 2 embodiments of the present invention. In this example, campaign manager 102 encompasses all of the functionality of the service provider facility. Also in this example, podcast host server 103 encompasses all of the functionality attributed to a podcast aggregator and listing service.

In this particular embodiment, Web service 111 may be made available as part of the functionality of campaign manager 102 wherein the actual service interface is distributed to and accessible from host server 103. In another embodiment, Web service 111 may be instead provided within and accessible from the service provider facility 102 as part of a local campaign manager suite. In the later embodiment, host 103 may provide a link to the service. There are many possible variations regarding actual hosting of service interaction and function.

In this case, service 111 includes a podcastor (publisher) registration interface 405 and an advertiser registration interface 406. Podcastors typically already registered with facility 103 and publishing commercial free podcasts may register with service 111 in order to publish commercial versions of there content. Advertisers may also register with service 111 in order to have advertising matched with podcast content. In one embodiment, the advertisers registering for advertisement placement services may already have audio advertisements created and ready to deploy. In some cases where videocasts are available, they may also have video advertisements ready for placement. An advertiser, much like the podcast publisher may, in one embodiment, publish advertisements that are ready to deploy using RSS so that they may be made accessible to and retrievable by the service of the present invention in similar fashion as was described with respect to podcasts. In another embodiment, the advertisers may simply upload their advertisements to the service, or indicate the URL location of those advertisement files so that the service may access them without using RSS. RSS provides a convenient method for locating and accessing files as well as for consuming those files at the point of the end user.

In this embodiment, publishers and advertisers need only provide the RSS feed and item identification and the advertising network service may perform the rest of the work. In one embodiment, server 103 may provide a unique RSS feed 407 containing an aggregate of the available podcasts from publishers who wish to carry advertising. The same feed may also be adapted to carry the aggregate of advertisement items that advertisers hope to have placed in the podcasts to end-users. In this embodiment, the RSS feed may not be publicly accessible, but may be accessible only to campaign manager 102 through RSS subscription. In this case, the service of the present invention may obtain all content items from the feed.

Podcastor and advertiser data solicited at registration may be stored in a data repository 404 for latter access during matching of advertising to podcast content and for accounting purposes. Repository 404 may be an external or internal storage medium such as may be known in the art including optical storage medium, server storage, external drive, raid array, or other possibilities. RSS content including podcast content and advertisement content may be input into a podcast studio application 401 within campaign manager 108 for matching and editing. It is noted herein that a digital studio solution may be external from campaign manager 108 without departing from the spirit and scope of the present invention. In one embodiment however, campaign manager 108 may include components that collectively provide all of the service function as an application suite or multi-component application.

In one embodiment, all of the podcast content obtained through RSS by the service of the present invention is downloadable multimedia content. However in some embodiments, podcast studio 401 may be equipped to play and record multimedia in order to obtain a copy of the podcast. The same may be true with respect to RSS delivered advertisements. For example, some monitoring may be required of podcasts and advertisements to insure audio quality or audio/video quality in a case of video-enabled podcasts. Likewise, such monitoring may help to determine where in a podcast advertisements will be presented. In one embodiment, advertisements may be concatenated to a beginning or end of a podcast or somewhere within a podcast if the files are edited using standard digital editing tools. In another embodiment for audio advertising, such advertising may be mixed in with podcast audio in specific portions of the cast. There are many possibilities limited only by current state-of-art digital editing capabilities available to the inventor.

Logically speaking, advertisements are pre-matched by the service of the present invention to podcast content before any studio editing occurs. In the case of a podcast that covers more than one subject in different segments of the podcast, advertising matching mat adhere to relevancy of the podcast content. There may be one or more than one advertisement concatenated or otherwise edited into a podcast and in some cases of more than one advertisement, the advertisers responsible for those advertisements may be separate and non-affiliated entities.

In one preferred embodiment, all of the content files accessed, obtained and used to create commercial podcasts are stored for subsequent access at the service location in a repository 113 labeled RSS content. Repository 113 then may contain all of the commercialized podcasts that may be published using a new RSS feed accessible to end users using Ipods and other suitable players as well as those using computer-based applications. Product output from studio 401, for example, consists of completed commercialized podcasts. Each item for an RSS feed may be represented via RSS file providing a summary of the content and, in some embodiments, a 30 second preview of the podcast item. Those finished podcast items may then be aggregated into on RSS feed 403 that is output to consumers. Any consumers subscribing to RSS feed 403 has access to the commercial versions or the podcasts. The complete multimedia files may be stored locally at the service in data repository 113 for convenient access.

In another embodiment, RSS files representing new commercial podcasts may be published back to service 103 and aggregated into the host RSS feed accessible from a podcast directory 408. In this embodiment, the commercial podcast may be available as a lower cost or free alternative to the commercial free version, which may require some compensation to download the entire podcast. This concept is logically represented in directory 408 through illustration of a Pay feed and a commercial feed, each feed listing one RSS podcast item, RSS-xx and RSS-xxa respectively. Both items represent the same podcast offering only one (RSS-xxa) contains advertising. In this embodiment whereby the feed or feeds are accessed, perhaps by end users accessing the feed through an Ipod or other download player, the consumer has an option to pay for and download the commercial free version of the podcast or to download a free version carrying one or more advertisements. This embodiment may also be applicable to streaming podcasts using real-time-streaming-protocol (RTSP).

In one embodiment of the present invention, a podcast aggregation and listing service may provide, in addition to RSS feed subscription services, a simple podcast directory listing that contains the commercial podcast selections created by the service of the present invention via campaign manager 108. In this embodiment, consumers accessing the directory to browse podcasts, by category or genre may simply click on the available play link and sample or listen to the entire commercial podcast without accessing any RSS feeds at all. In this embodiment, a subscribe link may be provided so that if the end user likes the sampled podcast, he or she may subscribe to other podcasts by the same author whether it be a subscription to an RSS feed available from the author's website or whether it be a customizable RSS feed offered through the host directory server. There are many possibilities.

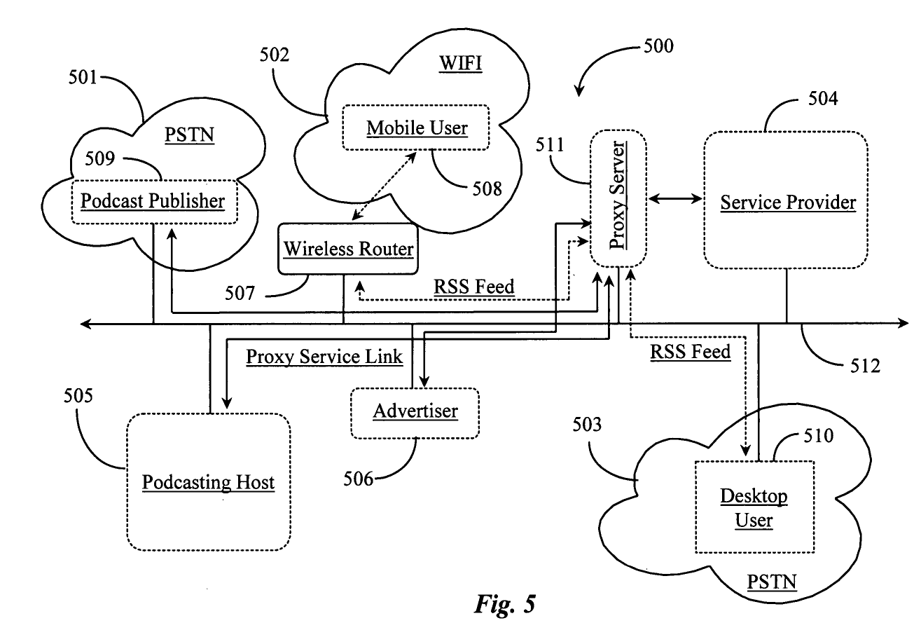

FIG. 5 is an architectural overview of a communication network supporting proxy service of RSS feeds containing commercial podcasts according to another embodiment of the present invention. Network 500 is analogous to communications network 100 in that it includes an Internet network represented herein by a network backbone 512 along with a PSTN network 501, a PSTN network 503, and a wireless network, in this case, a WIFI network 502. A service provider 504 represents all of the functionality of advertising network facility 102 described with reference to FIG. 1. A podcasting host 505 represents all of the functionality of podcast host 103 of FIG. 1.

A podcast publisher 509 illustrated within PSTN 501 represents publisher 118 of FIG. 1 and a desktop user 510, illustrated within PSTN 503 represents user 115 of FIG. 1. An advertiser 506 represents advertiser 104 of FIG. 1. A mobile user 508 illustrated in this particular example may represent any user accessing podcasts through RSS and a WIFI wireless infrastructure access network.

In this embodiment, podcasting host 505 may be a podcast aggregation system that provides podcast directory services and subscription links to one or more available RSS feeds containing podcast items. Podcast publisher 509 may publish new podcasts to host 505 as previously described. Actual podcasts may be uploaded to host 505 or linked through RSS to the publishers website where accessing consumers are driven when interacting with RSS feed items. However, in this case, the service of the present invention is made accessible to podcast publishers through a proxy server system 511. A publisher may access host 505 through proxy server 511 and also interact with proxy services transparently to host 505.

In this embodiment, the software of the present invention, which may be analogous to campaign manager 108 of FIG. 1 or podcast advertising suite 200 is accessible from proxy server 511. In this case, service provider 504 may have a co-brand relationship with podcast aggregation host 505 so that services maintained in and accessible through server 511 appear to be provided by host 505. In this way, publisher 509 and advertiser 506 may register for services through registration services offered through proxy 511. Server 511 has a proxy service link to host 505. In this case, publisher 509 may publish podcasts to host 505 through proxy server 511. Likewise, advertiser 506 may publish advertisements directly to proxy server 511 or to any other server maintained by service provider 504 and adapted for the purpose.

At server 511, the service obtains the published podcast items earmarked for commercialization when those podcasts are published to host 505. In one embodiment the podcast publisher identifies podcasts for commercialization so that the proxy server may recognize those and distinguish them from any podcasts that are intended to be commercial free podcasts. In this way, the service of the present invention may actually commercialize the intended podcasts and may publish them in a separate feed.

In this embodiment, advertiser 506 may publish advertisements through RSS directly to sever 511, or may simply provide those advertisements directly to service provider 504. RSS content including podcasts items may be retrieved from proxy server 511 and treated or processed by provider 504 and published back through server 511. Server 511 may provide a commercial feed alongside RSS feeds from podcasting host 505 in a manner that is transparent to the end user.

In this example, end user 510 may subscribe to commercial and non-commercial podcasts through proxy server 511. The commercial podcasts may actually be provided through service provider 504. Likewise, end user 508 may access the RSS feed from proxy server 511 through a wireless router 507 to download both commercial podcasts and commercial free podcasts. Feed access is logically illustrated by the broken lines labeled RSS feed placed between sever 511 and end users 508 and 510.

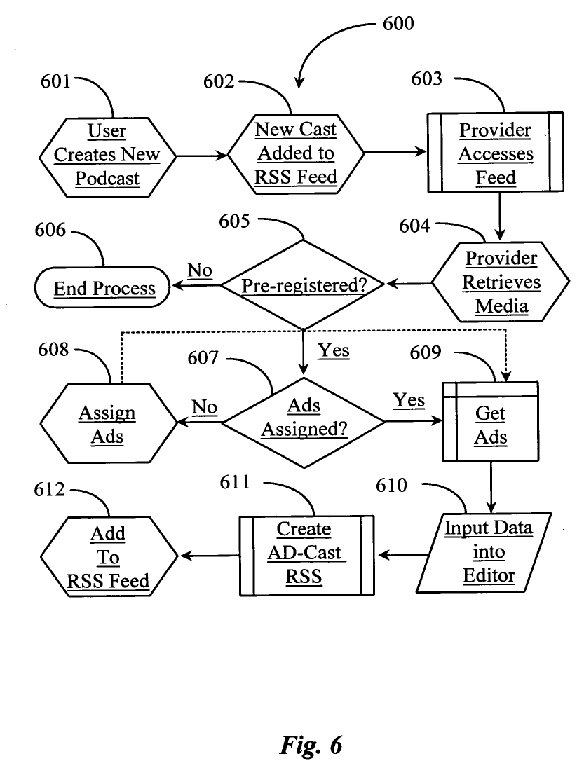

FIG. 6 is a process flow chart illustrating a basic process 600 for commercializing a podcast on behalf of a podcast publisher according to an embodiment of the present invention. At step 601, a user creates a new podcast for publishing. The user at step 601 is presumed registered with the service of the present invention and had indicated that the podcast is to be commercialized in advance of creating the podcast. In one embodiment, the created podcast may be tagged or marked for commercialization during the RSS publishing of the podcast. At step 602, the user publishes the podcast to an RSS feed. Step 602 is optional. In one embodiment, the user may upload a podcast directly to the service provided for commercialization. However, using RSS to enable retrieval of the podcast for editing is a convenient way of practicing the present invention and provides the service provider with an alert through RSS subscription that the RSS feed has been updated with a new item representing the podcast.

At step 603, the service provider accesses the RSS feed to parse the feed for new items to process. It is noted herein that the accessed feed may be an original RSS feed created by the author or publisher of each item found in the feed. In another embodiment, the feed may be a large aggregation feed that aggregates items from many different authors. At step 604, the provider may access the actual podcast multimedia files for editing. As described above, the podcast may be marked by the publisher for commercialization and therefore may be distinguished from other items that may be included in the feed.

At step 605 the service check to determine if the publisher is pre-registered to carry advertisements. If not, in step 606 the process ends and the service discards any retrieved items. If the publisher is pre-registered then at step 607, the system checks if there are any pre-matched ads assigned to the particular item retrieved. If no ads have been pre-matched for the particular item, then at step 608, the system may determine which advertisements are appropriate for the podcasts and may assign the advertisements to the podcast. Such an assignment may simply involve locating the advertisement or advertisements and confirming that those advertisements pass the criteria for approval for delivery through the podcast in question.

It is important to note herein that the advertisements may be pre-matched based on communication from the publisher without sampling any content to determine subject matter. In one embodiment, the service provider that accesses the feed at step 603 may parse a summary description (metadata), which references the podcast to determine or verify content for ad matching. In yet another embodiment, the podcast itself or a 30 second sample may be played after download for the purpose of verifying the subject matter for advertising. In still another embodiment, the podcasts are streamed to the provider and recorded as they are streamed.

At step 609, the advertisements that are determined suitable for placement with a podcast are accessed. In one embodiment, the advertisements are pre-stored at the location of the service provider having been submitted thereto by advertisers registered with the service. In another embodiment, the advertisements are accessed via an RSS feed in the same way the podcasts are. In this embodiment, summary data and any solicited data from publishers and advertisers are used to match the advertisements to the podcasts.

Once the service provider obtains all of the required items, they may be input into a multimedia editor or studio at step 610. At step 611, the service provider creates a new commercialized podcast or “Ad-Cast”. In this step, one or more advertisements may be concatenated to the podcast such that when the end user accesses the podcast, the advertisements and podcast play sequentially as ordered. In another embodiment, creative mixing and other editing capabilities may be used to provide the advertising as an overly to the podcast wherein the advertisement play over certain portions of the podcast. In still another embodiment, advertisements may be inserted into the meat of a podcast by sound mixing and recording processes. There are many editing and presentation possibilities. The exact editing service and method may be pre-determined through negotiation with the publisher and advertiser.

In step 611, the service may create an RSS file to publish the new commercial podcast. The service provider may actually store the commercialized podcast locally and at step 612, the service provider adds the new podcast to an RSS feed. The RSS feed may be hosted by the service provider and may be made available to end users through a service provider website. In this embodiment, the service provider may also provide a podcast aggregation service that aggregates all of the commercial podcasts created into one or more than one podcast feed. In one embodiment, the commercialized RSS feeds may reference music podcasts that may be downloaded to a handheld player. Motivation for downloading a commercial podcast instead of a commercial free podcast may be entirely monetary. For example, popular songs that may cost $1.00 or more to download may be downloaded free of charge is advertising is part of that podcast song.

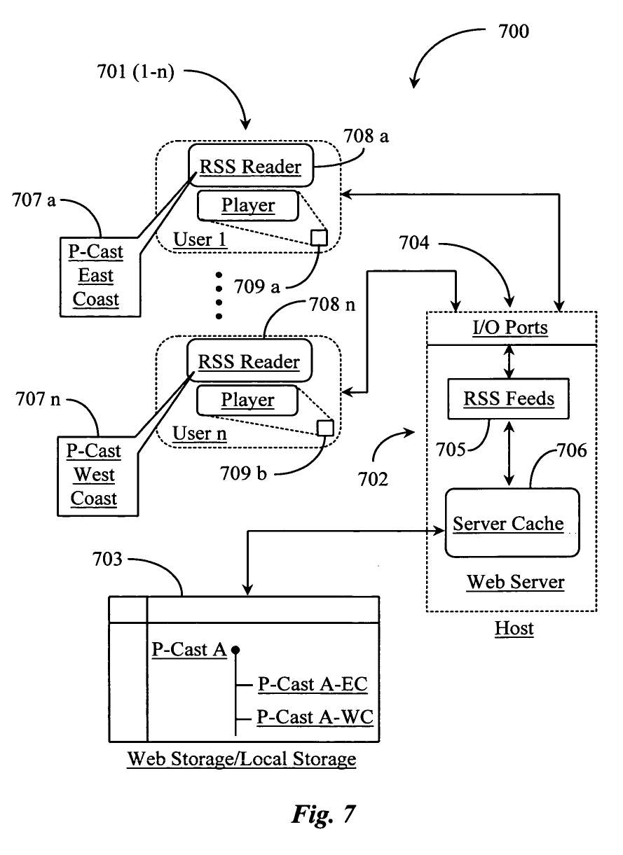

FIG. 7 is a block diagram 700 illustrating podcast commercialization according to audience demographics. Diagram 700 included a service provider host server 702 that is adapted according to an embodiment of the present invention to commercial podcasts to consumer subscribers. Host server 702 may be analogous to network server 112 described with reference to FIG. 1 above. It is assumed in this example, that server 702 is maintained by the service providing host that also commercializes the podcasts after brokering the relationships between the advertisers and podcast publishers and matching advertisements to podcasts based on those relationships.

Diagram 700 includes a plurality of end users 701 (1-n), also labeled User 1 through User n. Users 701 (1-n) are, in this embodiment, equipped with an RSS reader. RSS readers are illustrated in this example as an RSS reader 708a illustrated for user 1 and an RSS reader 708n illustrated for user n. User 1 also has a media player 709a for consuming podcast multimedia files and user n has a media player 709n for consuming podcast multimedia files. Users 701 (1-n) may be embodied as users who download and play media using a hand-held player like an Ipod, for example. In this case, the device is the player and RSS runs on the device to enable feed subscription and notification of new podcast media for consumption.

Host server 702 has appropriate Input/output (I/O) ports for communication as a web server. Server 702 publishes at least one if not several RSS feeds 705, which may reference commercialized podcast multimedia content. Server 702 has a server cache for caching multimedia content for download or streaming access by consumers who subscribe to particular podcast feeds. In one embodiment, users may also customize content by subscribing to several feeds that the server aggregates into one RSS feed channel. When users 701 (1-n) go online using their devices running RSS, any new commercialized content that is available is published to their devices via RSS and is ready to access.

Server 702 has connection to a mass repository 703 adapted to store actual podcast multimedia files including concatenated advertisement files. Web storage 703 may be a local media storage system with respect to server 702 for convenience, or it may be a remote storage system or even a plurality of accessible storage systems. Within storage system 703 there is illustrated 2 separate versions of a same podcast each version containing different advertisements. A podcast A (P-Cast A) is illustrated in a hierarchy with the 2 versions associated under the title. For example, P-Cast A-east coast (EC) is available and P-Cast A-WC is available. The version differs by the advertisements, which in this case, are determined appropriate for service in part by region in which a user accessing the podcast resides.

It may be assumed that the publisher of podcast A has identified 2 regions, East Coast and West Coast, which are important regions where subscribers to the publisher's material reside. Therefore the system may identify 2 types of advertising that satisfies the publisher's requirement. Content relevant advertisements that are localized to East Coast populations may be associated to one version of the podcast and those content relevant advertisements that are localized to West Coast populations may be associated to the other version of the podcast. Server 702 may determine which version of podcast A to serve an accessing user based on information that may identify the accessing user as an East Coast resident, or as a West Coast resident.

In state of art podcasting using RSS, a consumer may select an item presented in an RSS feed to access the item whereupon the user is presented with a web page (URL) containing further options before a podcast is actually executed for download. This case may be typical if a user is accessing the feed using a desktop or laptop computer with a video display unit (VDU). The RSS reader in this case presents a scrollable window that contains the web URL and possibly, several interactive options that the user may select using typical browser navigation functions. Therefore, in such an embodiment, the accessing user may click on a regional hyperlink to the podcast offering in order to obtain the media with advertising that is relevant to his or her location.

A user accessing the service from a hand held player may not enjoy full browser functionality because of limited display capability and selection options. However, in this case, the user, perhaps accessing the feed from an Ipod may be presented with both versions of the podcast A in a feed alert or update notification and may choose to download one or the other. There is sufficient input capability on most hand-held multimedia players to enable the selection process. In this example regardless of the accessing device, the consumer orders his or her podcast with advertisements that are relevant to the user's region by manually selecting the podcast reference that indicates the region of the user. At server side, there may be one separate multimedia podcast with advertisements for each defined region.

In another embodiment, the server may select the appropriate commercial cast to serve based on a global positioning service (GPS) for users accessing server 702 with devices that are equipped with GPS location services. In that case, advertising may be granulated to local advertising for users accessing from specific cities. In still another embodiment, the service may perform a network location function for each accessing user by checking the user's network address against a location service to determine, in the background, which podcast to serve the user. Other demographics might be incorporated into the advertising service other than location without departing from the spirit and scope of the present invention. For example, the service might have access to a user profile each time a user accesses the RSS feed to interact with an offering. In this embodiment during exchange, a light profile created in XML may be passed to the server, which may then parse the profile to determine which podcast is the correct one to serve. There are many possibilities.

In this embodiment, users 701 1 and 701 n are downloading the same podcast but the advertisement or advertisements that user 1 hears while listening to the podcast are East Coast relevant and the advertisement or advertisements that user n hears while listening to the podcast are West Coast relevant. In this way, advertisers may more closely target their advertising to those consumers of a podcastor's contents who might best fit the advertiser's profile of a best target audience.

One with skill in the art will recognize that subscribers currently access podcasts in a variety of ways including through RSS feeds. Another way podcasts are accessed is by browsing a podcast listing that aggregates and ranks podcasts by categories. In this embodiment, podcasts are not necessarily published to any RSS feed but may simply be accessed through normal browser function and the appropriate multimedia player for playing the selection. In this case, commercializing podcasts according to an embodiment of the present invention with demographically relevant advertising is still possible as long as the publishers, and advertisers, pre-register and consumers provide the relevant profile information for service determination of which commercial podcast version to serve. Moreover, those listed podcasts that are accessible from a web page without RSS may also be aggregated and made available to other sites and audience bases through RSS. However, a mechanism such as a web alert or other such notification is required for the podcast network service provider to be able to obtain the correct podcasts in order to commercialize them.

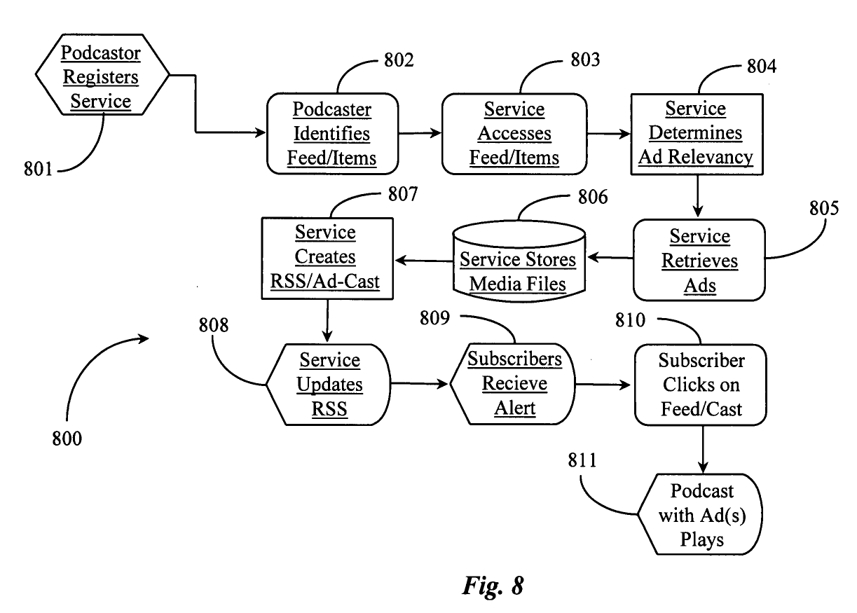

FIG. 8 is a process flow chart illustrating a process 800 for commercializing a podcast and for consuming the podcast after commercialization according to an embodiment of the present invention. At step 801, a podcastor registers with the podcast network service of the present invention. At this step the podcastor may provide information, preferences, and other data that the service may use to help select relevant advertising to serve with the podcast items published by the podcastor. It is important to note herein that a podcastor may by desire, create podcasts that are all relatively similar in subject matter such that advertisements may be matched to information and general subject matter provided by the podcastor during registration. For example, if a podcastor is publishing an ongoing fishing program, then it may be assumed that each podcast published by the podcastor may be categorized under the general topic of fishing.

However, in some podcast shows or programs there may be significant changes in subject matter from podcast to podcast. In a case like this, it may be more appropriate for the publisher to request advertisement matching on a more granular level with respect to any content relevancy criteria. Advertisers as well may appreciate a higher level of granularity so that their advertising is not associated with an un-related subject, which might equate to a largely unresponsive audience for the advertisement. Therefore, the service provider that matches the advertisements to the podcast may be required to sample or parse the podcast entirely to generate the content relevancy data used to identify which available advertisements would best fit the podcast content and likely the audience consuming the podcast. Still, it may be decided that some podcast publishers are so popular and have such a large subscriber base that advertisers are willing to place advertisements in any of their podcasts regardless of content relevancy.

At step 802, a podcastor may, in some embodiment, be required to identify an RSS feed and items (podcasts) contained in the feed that the publisher wishes to carry advertisements in. Once a publisher has registered to carry advertisements, the service may access the appropriate RSS feed or feeds and access the referenced podcast items for advertisement editing at step 803. At step 804, the service of the present invention may determine advertisement relevance for each reference podcast item. When a podcastor registers, he or she may have several commercial free podcasts already published that may be selected to carry advertising. In addition new published items may be tagged for commercial editing by the service.

At step 805, for each podcast to be edited, the service retrieves the relevant advertisement or advertisements. It is reminded here that other criteria may also be used in determining advertisement relevance including advertiser preferences, publisher preferences, cost limits, compensation minimums, and so on. Demographics and podcast ranking by third party services may also play a part in determining advertising or even if the podcast qualifies for carrying advertising at all. For example, the service itself may place certain requirements on podcast publishers before agreeing to register them with the service. The same may be true for advertisers. In this way the service may optimize the experience for podcastors and advertisers.

At step 806, the service may store all of the required media files (podcasts files and advertisement files) prior to studio editing. In one embodiment, the service may retrieve both podcasts and advertisements via RSS feed set up for subscribers to the service. At step 807, the service creates RSS podcasts with commercials or Ad-Casts. These new files may be stored for service and the original files podcast files and advertisement files may be discarded. The new podcast is commercialized and ready for access by consumers. At step 808, the service updates an RSS feed that is made available to end users so that they are alerted to new commercial podcasts. In this step, the feed may be an RSS feed hosted by the service, or it may be separated feeds hosted by the podcastors themselves in some cases. If a podcast publisher has a private RSS feed or one that is not shared by any other publishers, the commercial podcasts created by the service may be referenced in those feeds by updating those feeds with new RSS files.

In one embodiment, the service maintains its own RSS feed and aggregates all of the commercialized podcasts onto that feed for end consumers. There are many different market options that may be practiced without departing from the spirit and scope of the present invention. One preferred example is to provide commercial advertisement editing for music podcasts that may be subscribed to via RSS from end users operating hand-held players like Ipods. In this case, new commercial podcasts may be downloaded from a host PC by connecting the player. These podcasts may then be played back offline. In one embodiment for an Ipod or other hand-held device, location information may be exchanged when the device is connected to a PC. In this way local advertising may be presented to the user in a demographically correct way.

At step 809, subscribers (end users) that have subscribed to a commercial podcast feed or to a podcast feed of a specific podcastor that contains commercialized podcasts receive alerts if they go online after an RSS feed has been updated with new content. If the hand-held device is a cellular telephone adapted to download and carry music, then connecting online automatically triggers RSS alerts on the phone if RSS enabled. A cradled hand-held playback device may be configured to alert to the PC desktop of new items instead of automatically downloading those items by default.

At step 810, a consumer or subscriber may click on or select a feed and podcast item within the feed to initiate download and playback or, in some cases streaming of the content to the device. At this step, the commercialized podcast may be presented in a RSS feed subscribed to by consumers. In one embodiment, the service provider publishes its own RSS feed that aggregates the commercialized podcast offerings. A consumer downloading music to an Ipod, for example, may elect to subscribe to a commercial RSS feed because of a lower cost, or no cost, for music download wherein the music carries advertising. At step 811 the podcast carrying advertising plays over the speaker system of a playback device.

In one embodiment, the commercial podcast and the actual advertisement files that are associated with the podcast are stored separately and the advertisements are streamed to consumer devices whenever the consumer plays the podcast offering online. In this embodiment, the consumer playback device or module is configured to get the advertising before it plays the podcast offering. More detail on this embodiment is provided immediately below.

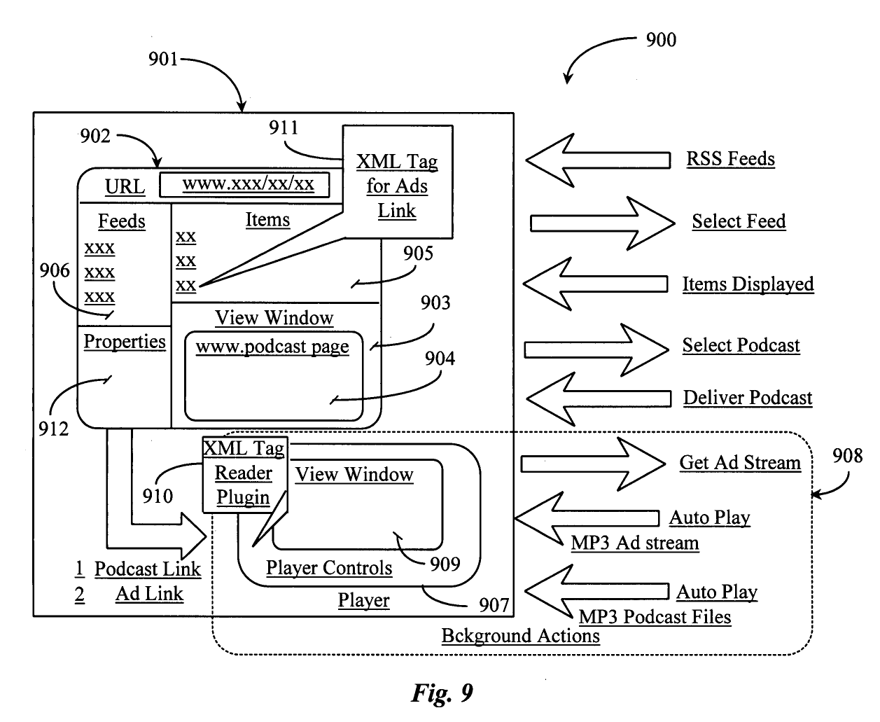

FIG. 9 is a block diagram 900 illustrating a streaming podcast advertisement process according to one embodiment of the present invention. A podcast download station 901 is illustrated in this embodiment, and minimally supports a version of an RSS reader 902 and a media player 907. RSS reader 902 is similar to a simple RSS reader that may be downloaded and installed on a computer appliance and then leveraged to subscribe to RSS feeds the consumer is interested in. Reader 902 has a displayable interface including a window 906 illustrated herein and adapted to list the RSS feeds that the consumer has subscribed to. RSS reader 902 also has an items window 905 illustrated herein and adapted to list items (podcasts) available from any one of the feeds listed in window 906. Therefore, when a consumer clicks on a RSS feed in window 906, items from that feed are displayed in list form within window 905.

RSS reader 902 further includes a content viewing window 903, which is adapted to display a URL associated with any of the items displayed for selection within window 905. In some cases, interaction with a feed item from window 905 will cause navigation to a hosting URL, illustrated in this example as www.podcast.net page 904, which may contain the actual podcast resource links that a consumer may click to initiate download or streaming of a podcast. In some embodiment, interacting with an item listed in window 905 results in immediate acquisition of the podcast offering.

In either of the above cases, invocation of the podcast resource link causes the podcast to be acquired at the station. Player 907 executes and begins downloading the podcast or the podcast streams to the device for immediate rendition. Player 907 includes, in this example, a content viewing window 909 and typical player controls. In one embodiment of the present invention, podcast station 901 is a peripheral handheld music player like an Ipod. In this case, display capability may be somewhat limited. Reader 902 may be provided in a light version and Feeds 906 and items 905 may be selectable by scrolling, highlighting them, and pressing an enter or play button. In a light embodiment for a handheld, device navigation capabilities may be quite different that what is available with a multifunction computer station with a VDU.

In this example following the arrows at upper right of the illustration and from top to bottom, RSS feeds are subscribed to from station 901 and are updated periodically with new items. The feeds and updates are pushed to station 901 whenever the station is connected to the prevailing network. The consumer may select any of the displayed feeds. At this point, the items within the feed are displayed in window 905. The consumer may then invoke any of the displayed items, which comprises an action for selecting, in this case, a podcast for consummation. Selecting the podcast item results then in delivery of the podcast to the device.

It is noted in this example, that at least one item within window 905 has an XML tag 911 that indicates that the item has advertising and provides a link to that advertising. Player 907 has an XML tag reader (plug-in) that reads the XML tag 911 and records the URL for the advertising. Player 907 performs some transactions in the background that are transparent to the podcast consumer. These background transactions are represented by a broken rectangular block 908 labeled background actions.

Following the arrows within block 908 from top to bottom, player 907 retrieves or gets an advertisement stream before retrieving and playing any podcast files. This action may occur whenever the player via reader 910 notices a tag in the item data. The advertisement stream is typically much smaller in size than the podcast media so the player may buffer this ad stream for playback while retrieving the podcast files. In this case, having retrieved the ad stream and buffered the ad stream, player 907 plays ad stream, which may be MP3 files for example. The consumer then listens to the ad stream before listening to the podcast stream.

When a user attempts to play a podcast that is associated with advertising, the playback device may be configured to attempt to go online, if not already online and retrieve the associated ad stream before the podcast may be played. In one embodiment, the user may download both the podcast and the advertisement files to a device. In this case, if the user invokes the podcast link the player will invoke the advertisement link locally and will play the advertisements and the podcast. In yet another more advanced, embodiment, the player streams both the podcast and advertisement files according to some pre-designed synchronized schema. For example, the podcast may be a newscast with no background music, just commentary. In this case the streaming advertisement may be mixed in with the podcast at such a point desired where the advertisement is heard as background under the commentary. There are many possibilities.

All that is required in the simplest embodiment is that the player be enabled to read some XML or HTTP tag associated with the podcast URL data that tells it to retrieve an advertisement from a separate URL, which is also provided. The method may work offline as well as online if the advertising files have been downloaded to the consumer's device or appliance. RSS is not necessarily required in order to practice the invention according to the above embodiment. If a consumer is simply browsing a podcast directory and clicks on a play link for an item, the player may obtain the instruction to retrieve and play an advertisement stream, the instruction received as a result of the previous action performed that invoked the player. It is noted herein that the advertising stream discussed herein may be an audio stream or an audio/video stream, if applicable. Moreover, the podcast may be an audio stream, a video stream, or an audio/video stream while the advertisement may be an audio stream, a video stream, or an audio/video stream in any combination without departing from the spirit and scope of the invention.

It will be apparent to one with skill in the art that in some cases a video playback module (software) may require some additional software components for enabling capabilities such as mixing and playing podcast and advertisement audio streams simultaneously over one speaker set, for example. Such components may include an audio mixing component, a video overlay component using such as windows-in-windows technology, and perhaps a duel buffer system and synchronization component for timing the streams to play appropriately. In a simple embodiment where an advertisement stream is retrieved, buffered, and played just before a podcast is retrieved, buffered and played, for example, no additional components other that a tag reader or parser to enable player response to a media retrieve instruction are required.

In the embodiment of streaming advertising from a location that is separate from the podcast media, real time streaming protocol (RTSP) may be used to rotate advertisements. For example, a user may, while online, invoke a podcast with advertising. That invocation may cause the player to retrieve a certain ad stream to play before the podcast selection is played. After a period of time the advertisements files at the advertisement source location (advertisement server) may be replaced with different advertisement files so that when the user plays the podcast a next time, the advertising is different. In an offline embodiment, perhaps using a hand-held music player, assuming prior download and latter playback of a podcast, the advertisement files would have to be part of the podcast media download for the advertisement to play if the podcast is played while the device is not connected online. However, the actual advertisement files may be stored in a separate part of the memory of the device and associated to the podcasts such that invoking the podcast still causes retrieval of the advertising from the local memory on the device in the offline state. In this case, a service may be employed to swap advertising files on consumer devices when cradled to a PC connected to the network-based service or otherwise connected online, with new and different advertising so that the next time the consumer plays a previously downloaded song offline, for example, a different advertisement plays.

In one case, after a consumer has downloaded one or more songs associated with advertising, (music download embodiment), the advertisements themselves may be programmed to terminate or self-destruct after a time leaving the consumer with a virgin commercial-free song. This concept may be used as a motivator to inspire consumers to download music with advertising at no cost or at a lower cost that commercial free music with the understanding that they must hear advertising associated with those songs only for a period of time, at the end of which, the advertising no longer plays when the song is invoked. In this way a consumer may obtain a lower cost collection of commercial free music.

What is claimed is:

1. An advertising network for selecting at least one pre-designed advertisement from a plurality of such advertisements, the selected advertisement made consumable in association with a podcast multimedia offering as a commercialized podcast to a consumer base comprising:
a receiving node ported for receiving podcast multimedia files or indication of the locations thereof and for receiving advertisement multimedia files or indication of the locations thereof;
a software interface supported by a processor for obtaining data about publishers of podcast multimedia and advertisement media;
a software instruction resident in memory and supported by a processor for associating the received or located advertisements to the received or located podcasts; and
a publishing node ported for facilitating access of the commercialized podcasts by a consumer base.

2. The advertising network of claim 1, wherein the prevailing network is the Internet network.

3. The advertising network of claim 1, wherein the advertisement is one of an audio advertisement or one of a video advertisement with or without audio sound.

4. The advertising network of claim 1, wherein the podcast is one of an audio podcast or one of a video podcast with or without sound.

5. The advertising network of claim 1, wherein the receiving node obtains multimedia podcast files via real simple syndicate protocol feed subscription.

6. The advertising network of claim 1, wherein the receiving node obtains multimedia advertisement files via real simple syndicate protocol feed subscription.

7. The advertising network of claim 1, wherein the software interface is a distributed web service.

8. The advertising network of claim 1, wherein data about publishers includes contact data, billing data, and preference information.

9. The advertising network of claim 1, wherein the software instruction depends on parsing of RSS feed content and consultation of publisher preferences and a rules base.

10. The advertising network of claim 1, wherein the publishing node is part of a podcast aggregation and listing service.

11. The advertising network of claim 1 further including an RSS feed subscription module running at the software interface for updating the receiving node whenever there are new podcasts to commercialize and/or advertisements for placement.

12. The advertising network of claim 7, wherein the location of the web service is a third party podcast aggregation service.

13. The advertising network of claim 1 further including a digital studio editor for concatenating selected advertisement multimedia files to podcast multimedia files.

14. The advertising network of claim 13, wherein the digital studio is further enhanced for mixing sound files of podcasts and advertisements together creating new multimedia files representing a commercial podcast.

15. A software suite for facilitating multimedia file acquisition, rendering, and publishing of those files in the form of one or more commercial podcast offerings accessible by a consumer base comprising:
a web service interface to podcast publishers and advertisers for obtaining data pertinent service data and for obtaining targeted publisher multimedia files and advertiser multimedia files;
a data processing layer for enabling matching of advertisements to podcasts;
an interface to a digital editing application; and
a podcast publishing layer for publishing available commercialized podcasts to the consumer base.

16. The software suite of claim 15, wherein the Web service is distributed to a third-party podcast aggregator.

17. The software suite of claim 15, wherein real simple syndicate is used for obtaining targeted publisher multimedia files and/or advertiser multimedia files.

18. The software suite of claim 15, wherein the service data includes contact data, billing data, and preference data.

19. The software suite of claim 15, wherein the digital editing application is a third-party digital studio.

20. The software suite of claim 15, wherein the podcast publishing layer includes an RSS feed generator.

21. The software suite of claim 15, wherein rendering may include file concatenation of advertisement media to podcast media.

22. A method for service brokering and fulfillment for advertisement placement of an advertisement into a podcast multimedia offering on behalf of a podcast publisher and advertiser including acts for:
(a) registering the podcast publisher for advertisement acceptance;
(b) registering the advertiser for advertisement placement;
(c) receiving the podcast from the podcast publisher;
(d) receiving the advertisement from the advertiser;
(e) matching the advertisement received to the podcast received;
(f) editing the matched entities to produce a commercial podcast offering; and
(g) publishing the commercial podcast offering to a consumer base.

23. The method of claim 22 wherein in act (a), registration includes taking of contact information, advertisement preference information, and account information.

24. The method of claim 22 wherein in act (a), registration is accomplished though a web service interface.

25. The method of claim 22 wherein in act (a), registration further includes identification of an real simple syndicate feed referencing the podcast multimedia offering targeted for commercialization.

26. The method of claim 22 wherein in acts (a), registration includes taking of contact information, billing information, and publisher preference information.

27. The method of claim 22 wherein in act (b), registration further includes identification of a real simple syndicate feed referencing the multimedia advertisement targeted for placement.

28. The method of claim 22 wherein in acts (c) and (d), the multimedia files are obtained via subscription to RSS feeds referencing the files as items, the items invoked to receive the files.

29. The method of claim 22 wherein in act (e), matching is based in part on content relevancy and in part on monetary considerations.

30. The method of claim 22 wherein in act (f), editing is performed using a digital studio application.

31. The method of claim 22 wherein in act (g), the commercial podcast is published via real simple syndicate feed.
